(19) United States
(12) Patent Application Publication
(10) Pub. No.: US 2008/0077633 A1
(43) Pub. Date: Mar. 27, 2008

(54) METHOD FOR POLICY-BASED DATA PLACEMENT WHEN RESTORING FILES FROM OFF-LINE STORAGE

(75) Inventors: Marc A. Kaplan, Katonah, NY (US); Wayne A. Sawdon, San Jose, CA (US); Frank B. Schmuck, Campbell, CA (US)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/534,897

(22) Filed: Sep. 25, 2006

(51) Int. Cl. G06F 17/30

(52) U.S. Cl. 707/204

(57) ABSTRACT

During file backup to an off-line storage facility, attributes are included which facilitate the placement of the file into a proper pool during a subsequent restoration operation. This avoids multiple data transfers that may have otherwise been occasioned as a result of improper pool selection during the restore due to the loss or to the unavailability of necessary file attributes when the file was restored.

### TECHNICAL FIELD

The present invention is generally directed to data file backup and to subsequent restoration of files from an off-line facility. More particularly, the present invention relates to a system and method which takes advantage of specific file attributes to improve data file placement during a restoration operation.

### BACKGROUND OF THE INVENTION

Modern data storage devices offer a range of performance and reliability characteristics. File systems supporting disparate storage devices often segregate the devices by their characteristics into “storage pools.” The user or system administrator may then specify policies to control the placement of user data into specific storage pools in order to provide desired performance or reliability. Other policies may then control the data movement through the storage hierarchy or may specify rules for data retention and deletion. The policies are written to match attributes of the data, such as file name, owner, size, time since last access or possibly the contents at known locations in the file or even as elements of markup tags such as those defined by the Extended Markup Language (XML).

When a file is first created, very little is known about the file, thus the initial placement is often not the best choice. However, during use of the file, rules are employed that migrate or delete existing files. These rules use processes that have access to a greater number of file attributes than were available during the initial placement, including such things as its size, modification times, usage and even indeed, all of the file's contents.

When a backup utility restores files that were saved in off-line storage, it uses the same system calls to create the file as during the initial file creation, and therefore suffers from the same limitations on proper file placement. Furthermore, the restore process typically runs as root (system administrator), rather than the original file owner, to avoid permission or quota checks. This even further reduces the valid attributes available for placement during a restore operation. For this reason, systems today do not offer policy-based placement during restore operations. The net result is that data restored into a file system that partitions its storage must write the data twice: once when a file is restored, and a second time when a subsequent migration moves the file to the preferred pool. The lack of proper placement at the time of file restoration time may even cause the restoration operation to fail, due to lack of space in the storage pool chosen for the restore.

### SUMMARY OF THE INVENTION

The shortcomings of the prior art are overcome and additional advantages are provided through a system and method for restoring a file from off-line storage in which specific file attributes are saved during off-line backup of the file. At least one restore policy rule is defined which utilizes these specific file attributes. These policy rules are employed in conjunction with the specified file attributes during a file restoration operation so as to place the file in a proper storage pool.

At the time a file is backed up to off-line storage, all attributes about the file are available, including its current storage pool assignment. These attributes are packed into an opaque structure and backed up with either the file data or its extended attributes such as its Access Control List (ACL). The ACL specifies which users and groups are allowed to access the file and specifies such things as whether or not read or write authorization is a permitted. As used herein, the phrase “opaque structure” means that the backup utility need not be aware of the content of the structure and need not understand the meaning of the attributes. The point is that any existing backup utility is usable in conjunction with the present invention without the need to modify the backup utility. The backup and restore utilities may not be aware of the extra attributes or their purpose. However, during a restore operation, these attributes allow the file to be restored to its previous pool, or, if desired, allow the storage pool to be selected based on a restoration policy using the full range of attributes that were available when the file was backed up, including the original owner, file size, access times, modification time, etc. The extra attributes enable more selective policy rules to be employed. These rules allow the data file to be immediately placed in the proper pool, thus avoiding the subsequent data migration that is currently the most likely outcome. Additionally, the wider range of file attributes employed allow migration/deletion rules to be more selective and to make a more informed placement choice. Other file attributes, such as the file's reliability factor, performance criteria or retention period, may also be saved and restored.

Additional features and advantages are realized through the techniques of the present invention. Other embodiments and aspects of the invention are described in detail herein and are considered a part of the claimed invention.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram illustrating the systems and the main data flow path present in backup and restoration processes; and

FIG. 2 is a block diagram illustrating the systems and the main data flow path present in backup and restoration processes in which the present invention is employed.

### DETAILED DESCRIPTION

In accordance with one embodiment, the present invention employs three steps: the first to save the necessary attributes during the backup, the second to define the restore policy rules and the third to apply the restore policies to the file attributes during the actual restore operation to select the proper storage pool for the file's data.

The backup utility runs by scanning the file system, looking for new files or files that have changed. It then opens the file, obtains the attributes, permissions, and if the data has changed, it copies the data as well. The backup utility stores the information off-line, then continues scanning for additional files to be backed up. During this step, we collect the policy attributes and return them with each file, preferable as an opaque, extended attribute of the file or, alternatively, as the first bytes of data. Returning the policy attributes with the file attributes allows the backup utility to avoid copying the data each time the file migrates between on-line storage pools.

The restore rules are installed as part of the file system's configuration, but may be updated at any time. Each rule specifies a criteria that a file should meet to be selected for the designated pool. Typically, there is a “default” rule that matches all unselected files. The criteria may be based on file attributes, file content, current storage pool utilization, etc. Policy rules for restoring files differ from the original placement rules to allow for the wider range of attributes available during the restore operation, namely, the original file attributes. Other selection criteria may be used such as: current file attributes, current state of the file system, current storage pool utilization, current date and time, or even random assignments.

In its most typical use, the present invention performs restore operations based upon saved file attributes, but the restore rules are more general than this. In particular, the restore rules may also consider other factors, including attributes about the new file, the state of the current file system, the current time or even random numbers. Some of the restore criteria are therefore seen to possibly be outside a file's attributes per se; nonetheless, they are still usable in conjunction with the present invention.

The restore utility runs by starting with a list of files or directories that are to be restored to the on-line file system. This may be a complete restore, say after a hardware failure, or it may be a partial restore, say only the files for a single user. The file system is on-line and available for regular use while the files are being restored. The restore utility runs as root. For each file to be restored, the utility creates the file in the on-line file system, restores the file's attributes, then the file data and finally restores the file's timestamps. Before restoring the data, when the file attributes are restored, the policy attributes are parsed and the file is assign to the appropriate storage pool. This may involve using the installed policies to select the pool or simply assigning the file to its prior pool. Other file attributes, for reliability, performance or retention, may also be restored or selected via the installed policies. Once the pool is assigned, the file data is restored immediately to the proper location.

As described above it is seen that the focus of the save and restore operations is directed to storage pool identification. However, it is noted that the same method is also employable for saving and restoring other file indicia such as its replication factor (for reliability), its reliability factor or performance criteria. In particular, it is desirable to extend the attributes saved to include additional information on performance criteria to insure that a restored file has the same access performance as the original.

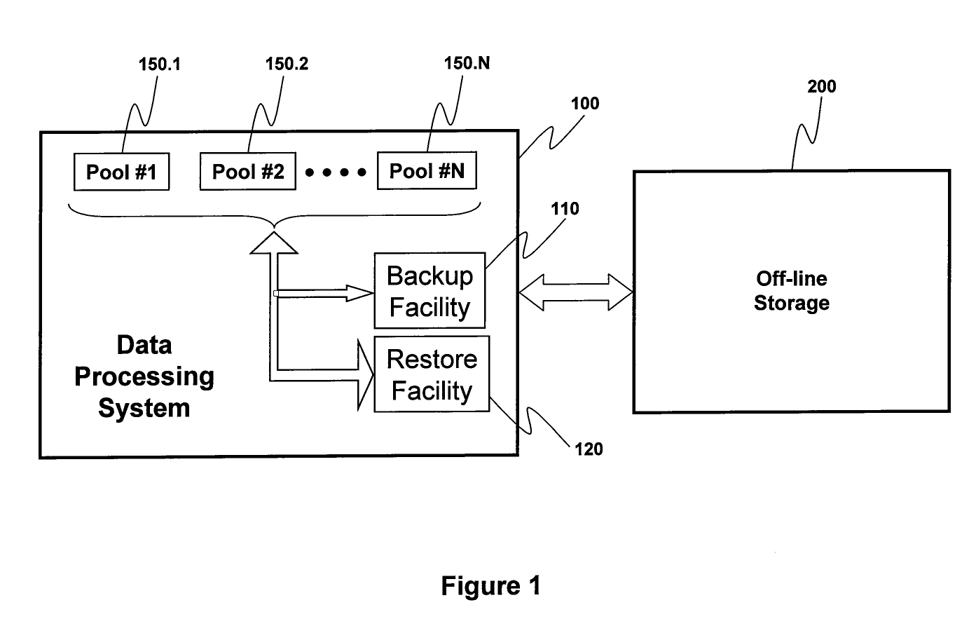

FIG. 1 illustrates the environment in which the present invention is employed. In particular, there is present data processing system 100 which includes pools of storage devices 150.1 through 150.N. Data processing system 100 also includes a backup facility 110 and a restore facility 120. These facilities work together to perform operations to backup data from one or more members of the storage pools to off-line storage 200.

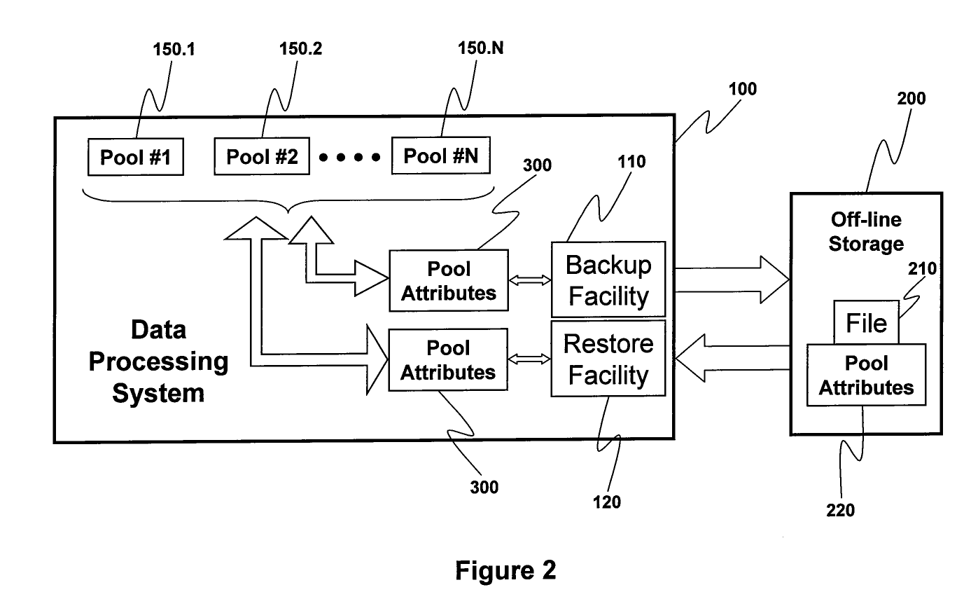

FIG. 2 illustrates in block diagram form, the improvements provided by the present invention. In particular, the system and method of the present invention include pool attributes in the backup process. These are shown in FIG. 2 generically as “pool attributes” 300. These are attributes of stored files which facilitate the restoration process to better place a restored file into a more appropriate pool. In a backup operation, a file and/or its file data are moved to off-line facility 200 where it is stored as file 210. These attributes are associated with the file data 210 as shown by block 220. This association may take several forms. The pool attribute information may be embedded in the file itself or included in a separate file that is linked to the file to which the information pertains. Either method falls within the contemplated scope of the present invention. In the restore operation, restore facility 120 restores the file attributes, including the saved pool attributes 300, before restoring the file data. This allows the file system to select the appropriate storage pool, 150.1 to 150.N based on the attributes saved when the file was backed up. Once selected, the file data is restored directly to the proper pool.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A method for restoring a file from off-line storage, said method comprising the steps of:
saving specific file attributes during off-line backup of said file;
defining at least one restore policy rule which utilizes said file specific file attributes; and
employing said at least one restore policy rule with said specific file attributes during file restoration so as to place said file in a proper storage pool for said file.

2. The method of claim 1 in which said policy rule is part of a file system configuration.

3. The method of claim 1 in which at least one said rule specifies a criteria that a file meets to be selected for the designated pool.

4. The method of claim 3 in which said criteria are selected from the group consisting of: original file attributes, current file attributes, current state of the file system, storage pool utilization, current time, random assignments, file replication factor, current date and time, file content and current storage pool utilization.

5. The method of claim 1 in which there is a default policy rule that applies to unselected files.

6. The method of claim 5 in which the default policy for unselected files is to restore them to their original pool.

7. The method of claim 1 in which said restoring is a complete restoration.

8. The method of claim 1 in which said restoring is a partial restoration.

9. The method of claim 1 in which said file attributes are selected from a group consisting of: pool assignment, file owner, file size, file access times and modification time.

10. The method of claim 1 in which said file attributes also include indicia not related to pool assignment.

11. The method of claim 10 in which said indicia are selected from the group consisting of reliability, performance and retention to be restored from the saved file attributes.

12. The method of claim 11 in which said indicia not related to pool assignment are restored.

13. The method of claim 1 in which file criteria such as reliability, performance and retention is selected via at least one restore policy rule.

14. A method for backing up a file to off-line storage, said method comprising the steps of:
scanning the file system to find a new or changed file;
obtaining attributes and permissions for said found file;
determining if data in said file has changed; and
storing said file in an off-line facility together with attributes indicative of a storage pool in which said file is stored.

15. The method of claim 14 further including the step of scanning said file system for other new or changed files.

16. The method of claim 14 in which the attributes, which indicate storage pool location in which said file is stored, are stored in said off-line storage within the file itself.

17. The method of claim 14 in which the attributes, which indicate storage pool location in which said file is stored, are stored in said off-line storage within a separate file linked to said file.

18. The method of claim 14 in which the attributes, which indicate storage pool location in which said file is stored, are stored in said off-line storage as an extended attribute for said file.

19. A method for handling a data file in a data processing system, said method comprising the step of:
backing up said file to off-line storage together with attributes which facilitate determining storage pool location during a subsequent restore operation.
